(19) United States
(12) Patent Application Publication
(10) Pub. No.: US 2007/0239856 A1
(43) Pub. Date: Oct. 11, 2007

(54) CAPTURING BROADCAST SOURCES TO CREATE RECORDINGS AND RICH NAVIGATIONS ON MOBILE MEDIA DEVICES

(76) Inventor: Essam Emest Abadir, Lancaster, PA (US)

Correspondence Address: Essam Abadir, 42 N. Lime St., Lancaster, PA, 17602, US

(21) Appl. No.: 11/277,412

(22) Filed: Mar. 24, 2006

(51) Int. Cl. G06F 15/16

(52) U.S. Cl. 709/219

(57) ABSTRACT

The present invention provides a capture system for creating recordings associated with a user, the capture system comprising a capture portal, including a recording broker for creating a schedule for making recordings and a rich navigation broker for deriving rich navigation metadata associated with the recordings. The capture system further provides a capture device, including a communication agent for receiving information—said information including a recording schedule and rich navigation metadata, a broadcast receiver for receiving multimedia, a recording agent for beginning a the recording of a segment of multimedia based on the recording schedule, and a rich navigation agent for associating rich navigation metadata with the recording.

### TECHNICAL FIELD OF THE INVENTION

The present invention is directed to a capture system for creating recordings.

### BACKGROUND

Television is used by millions of consumers both as a source of information and entertainment. Cable, satellite, and internet broadcasts (such as IPTV) can supplement local over-the-air broadcasts to provide hundreds of channels of programming. Consumers with busy schedules may not always be in-front of their television sets when these programs are aired. Consequently, a number of electronic devices that can record broadcast television transmissions have been developed. These devices can generally be categorized as Video Cassette Recorders (VCRs) and personal video recording devices (PVRs).

Personal video recorders may include an internal hard-drive on which recorded broadcast transmissions may be stored for simultaneous or future (time-shifted) viewing. Others have the ability to regularly record the user's favorite television series. More advanced features are also commonplace such the ability to regularly record the users favorite television series or record all movies with a particular actor. Advanced personal video recording devices (hereinafter APVR s) such as TiVo™, Replay TV™, Sage TV™, Microsoft Media Center™, Myth TV™, and others are now widely available to the consumer public.

APVRs are optimized for simultaneous capture and display of broadcast media at a known geographic location by a home-consumer. For example, a home-consumer might have an APVR device in the living room of his home on which he may schedule, record, store and simultaneously watch video on the television attached to that APVR.

APVRs are primarily targeted at home-applications for viewing on television or computer monitors. Another set of devices for consuming media content are now widely available in the form of devices such as MP3 players, Apple iPod Photo™, Apple iPod Nano™, Apple iPod Shuffle™, mobile phones, personal digital assistants (PDAs) and myriad other devices—collectively hereinafter referred to as “Mobile Media Devices” (MMDs). Consumers that want to consume media on MMDs (mobile-consumers) are not the focus of the APVR.

### SUMMARY OF THE INVENTION

The present invention provides a capture system for creating recordings associated with a user, the capture system comprising a capture portal, including a recording broker for creating a schedule for making recordings and a rich navigation broker for deriving rich navigation metadata associated with the recordings. The capture system further provides a capture device, including a communication agent for receiving information—said information including a recording schedule and rich navigation metadata, a broadcast receiver for receiving multimedia, a recording agent for beginning a the recording of a segment of multimedia based on the recording schedule, and a rich navigation agent for associating rich navigation metadata with the recording.

The objects, advantages and features of the present invention will become more apparent when reference is made to the following description taken in conjunction with the accompanying drawings.

### BRIEF DESCRIPTION OF THE DRAWINGS

FIG. 1a depicts an exemplary rich navigation.

FIG. 1b is a block diagram illustrating the capture system.

FIG. 1c is an exemplary screen for selecting broadcasts sources.

FIG. 2a depicts an exemplary process for recording broadcasts and transferring rich navigation using the capture system.

FIG. 2b depicts an exemplary use of an MMD and MMD Host.

FIG. 3 is a block diagram of the capture portal according to an exemplary embodiment of the capture system.

FIG. 3a is an exemplary program grid for selecting broadcasts programs for recording.

FIG. 4 is a block diagram of the Capture Device according to an exemplary embodiment of the capture system.

FIG. 5 illustrates an exemplary process for determining the component media configurations of recordings.

FIG. 6 illustrates an exemplary process for determining rich navigation metadata for recordings.

### DETAILED DESCRIPTION

Portable handheld devices such as MP3 players, Apple iPod Photo™, Apple iPod Nano™, Apple iPod Shuffle™, mobile phones, personal digital assistants (PDAs) and myriad other devices—collectively hereinafter referred to as “Mobile Media Devices” (MMDs)—are now common among consumers. Hereinafter, “media configurations” refers to both transcodings of media—such as the transcoding of MPEG2 to MPEG4—as well as other novel transformations of the base media as detailed below. Typically, MMD's hold a relatively large number of recordings relative to the media they typically play, e.g. most iPod™ devices hold hundreds or even thousands of songs. Without navigation metadata it is extremely laborious to call up particular media items on an MMD using lists of hundreds of items viewed on screens with between 1 and 3 inches of vertical visual real estate. “Rich navigations” go beyond canned association of recorded media to particular categories or sorted lists such as groupings by program title or sorting by date or title. It will be appreciated the richer the navigation the user wishes to maintain the more laborious the task of manual creation and maintenance of such rich navigations becomes. Rich navigations are facilitated by rich navigation metadata as discussed below.

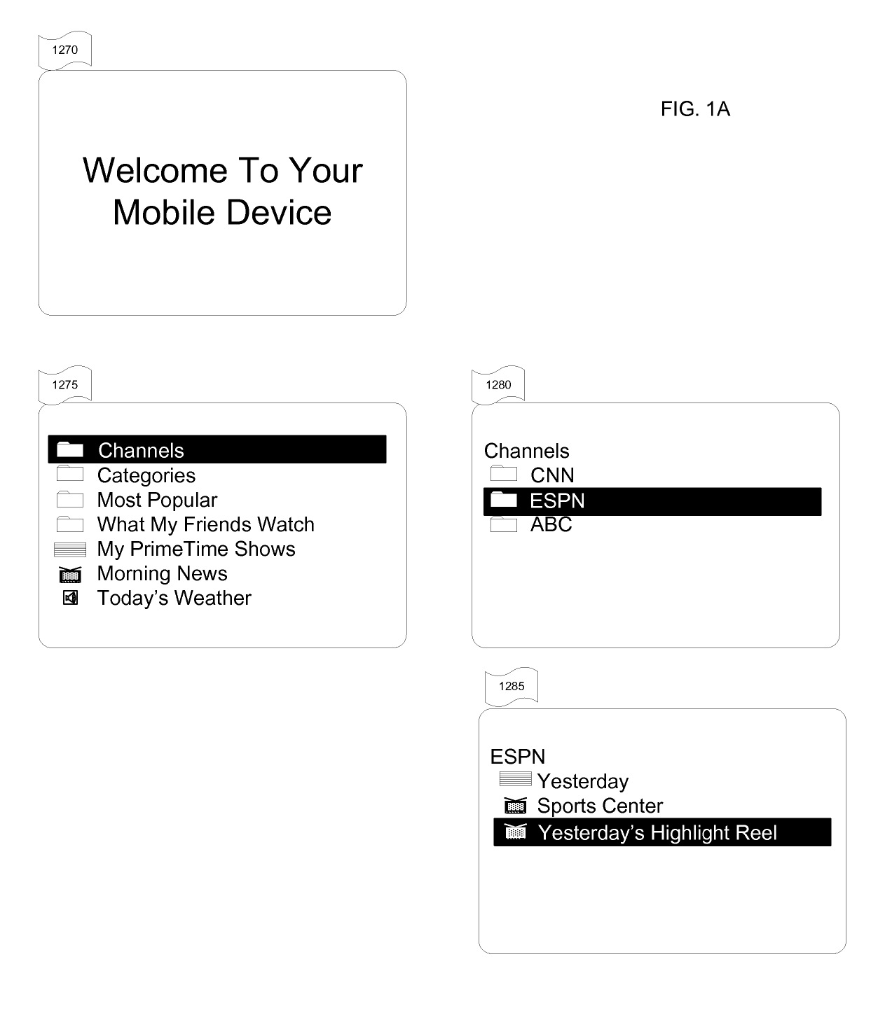

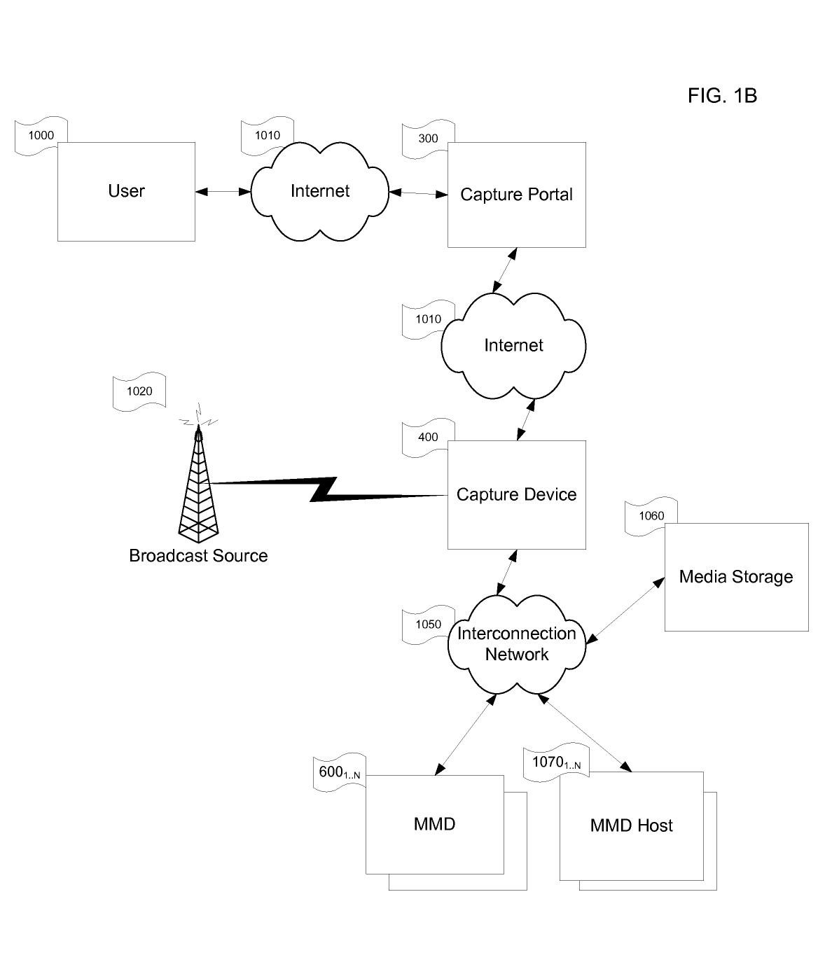

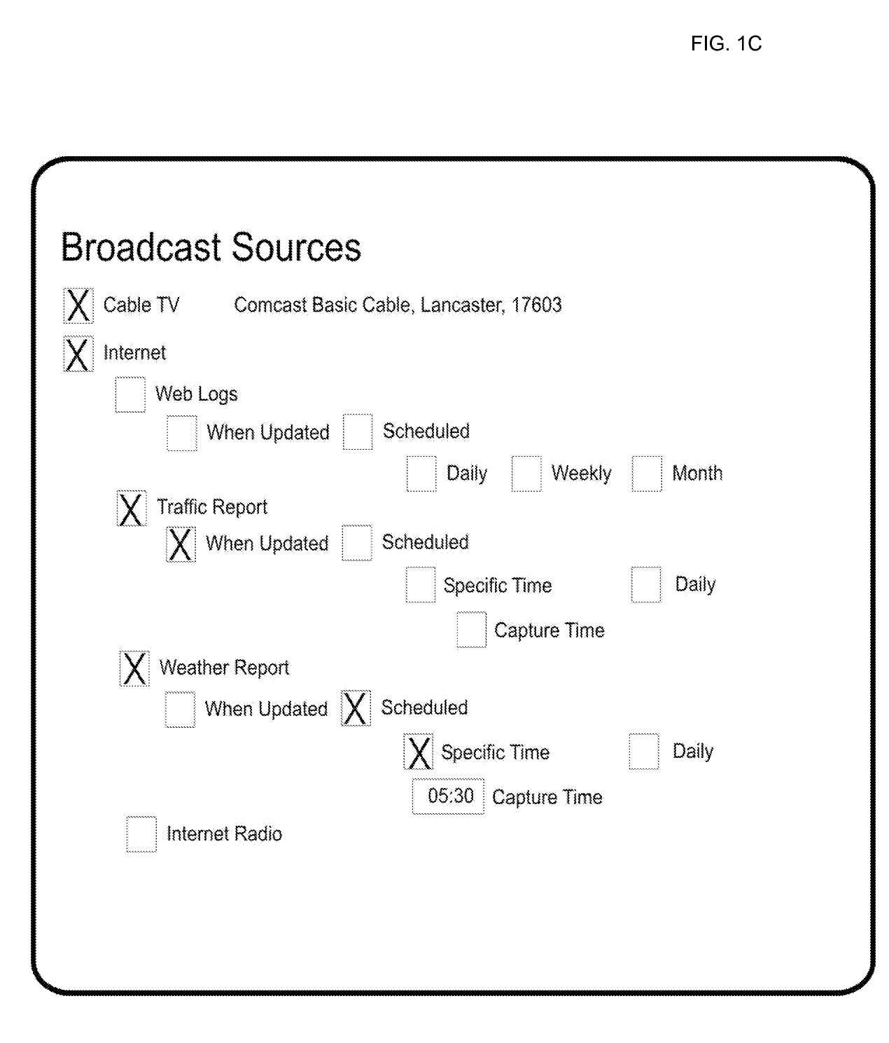

FIG. 1a depicts an illustrative rich navigation that is typical of MMDs but not APVRs. Typically APVR devices hold relatively few media recordings (usually tens of media recordings) when compared to MMDs such as iPod Nano™ (hundreds of media recordings). To facilitate navigation of so many media recordings MMDs typically support concepts such as “folders” and “playlists” to organize media. These concepts allow for rich navigation” as depicted in FIG. 1a. For example, after the user at screen 1270 turns on his MMD, the user, at screen 1275, is immediately presented with both the items of greatest relevance to the user and a means of browsing the many recordings he might have. Folders are typically a visual group of items that pertain to a particular subject matter, for example, in screen 1275 the folders “Channels”, “Categories”, “Most Popular”, and “What My Friends Watch” are depicted. A playlist “My PrimeTime Shows” is also depicted on screen 1275 along with a video “Morning News”, and an audio recording “Today's Weather”. A playlist is a list of recordings that will be played in sequential order. “Smart playlists” may be generated programmatically when, e.g., a user adds a recording that shares a common piece of metadata such as the album name—in this example the smart playlist is a programmatically generated playlist consisting of all songs from that album. Smart playlists are made possible through metadata tagging and rule engines being applied to the meta-data associated with the recording. The user at screen 1275 selected the “channels” folder and is then shown screen 1280. At screen 1280 there is a folder corresponding to each broadcast cable channel the user has recorded from, in this example CNN, ESPN, and ABC. At screen 1280 the user selected ESPN and is taken to screen 1285 where he selects to watch the video “Yesterday's Highlight Reel”. The use of folders, playlists, metadata tagging, smart-playlists, and other elements for purposes of assisting navigation of the titles in a media library will hereinafter be referred to as “rich navigation”. The data describing a rich navigation will hereinafter be referred to as “rich navigation metadata”.

In a household environment where the user is generally at leisure to browse the library of recordings on the relatively large screen of a TV there is less need for rich navigation than when a mobile-consumer who is “on-the-go” attempts to navigate many more recordings the much smaller screen of an MMD. The mobile consumer is likely to be walking, running, in a vehicle, etc. and multitasking such that his hands are otherwise engaged. If, by way of example, the mobile consumer has a particular preference such as sports, it would be beneficial, as in screen 1285, to have the previous day's sport highlights composed into a rich navigation “highlight reel” that play sequentially so that the mobile-consumer does not have to constantly interact with the MMD in order to queue up the next media item or to fast-forward through items etc. to get to the interesting bits. Such a highlight reel could be accomplished through a playlist referencing segments of multiple recordings or, alternatively, as depicted in screen 1285 the highlight reel may be a single video recording composed of segments of multiple broadcasts. Such a recording composed of segments from multiple broadcast programs or sources will hereinafter be referred to as a “composite recording”.

FIG. 1b depicts the components of the system according to preferred embodiments of the capture system. A capture portal 300, such as might be implemented on a web site, provides a venue for users 1000 to schedule the capture of broadcast sources. Those skilled in the art will appreciate that a portal approach allows that all users always have access to the most up-to-date features and data, such as scheduling features and program data, and also to uniquely customize the user-interface (UI) based on the interests of the user—e.g. the users with a high interest in sports programming might be greeted with a schedule display showing only sports related programs. As detailed below the capture portal 300 preferably remotely controls the capture of broadcast transmissions by transmitting data related to the scheduling of recordings, hereinafter “schedule items”, through the Internet 1010 (or other wide area network) to the user's capture device 400. Similarly, rich navigation metadata is transmitted from the capture portal 300 to the capture device 400, through the Internet 1010.

The capture device 400, as further detailed below, receives a broadcast source, 1020, and uses the retained scheduled recording information from the schedule items to tune to particular transmissions at particular times and record the media in the specified configurations as dictated by the capture portal 300. Recorded media is stored to Media storage 1060 which may be an internal hard-drive on the capture device 400 or may be externally accessible through the interconnection network 1050. The interconnection network 1050 is a logical entity that may be comprised of any number of interconnection technologies such as, but not limited to, USB, FireWire, SCSI, InfiniBand, SATA, Bluetooth®, WiFi, Ethernet, Cell Phone networks, etc. The capture device 400 furthermore acts as a repository for rich navigation metadata that will be transferred to the MMD Hosts 1070_{1 . . . N}. The MMD Hosts 1070_{1 . . . N} may be physically located on the Capture Device 400 or may be connected to the capture device through an Interconnection Network 1050. Subsequently rich navigations will be transferred from the MMD Hosts 1070_{1 . . . N} to the respective MMDs 600_{1 . . . N} of the mobile-consumer through an interconnection network 1050.

Broadcast sources include, but are not limited to any widely available media source that is scheduled or can be recorded according to a schedule. Examples of broadcast sources include, but are not limited to, cable television, over-the air broadcast television, satellite television, satellite radio, internet-radio, and internet web pages. FIG. 1c depicts an exemplary screen on the capture portal for configuring broadcast source selection. Broadcast sources include any information that is broadly available and can be captured at scheduled intervals such as, but not limited to, those depicted in FIG. 1c. When taken in conjunction with multiple output configurations of the source broadcast a traditional television program might transformed into an audio only program or an automated slide-show with accompanying audio. As another example, of the vast permutations of broadcast sources to transformed configurations the text from a web log (commonly known as “blogs”) can be converted to synthesized speech and the images then combined into an audio enhanced slideshow with the afore mentioned synthesized speech.

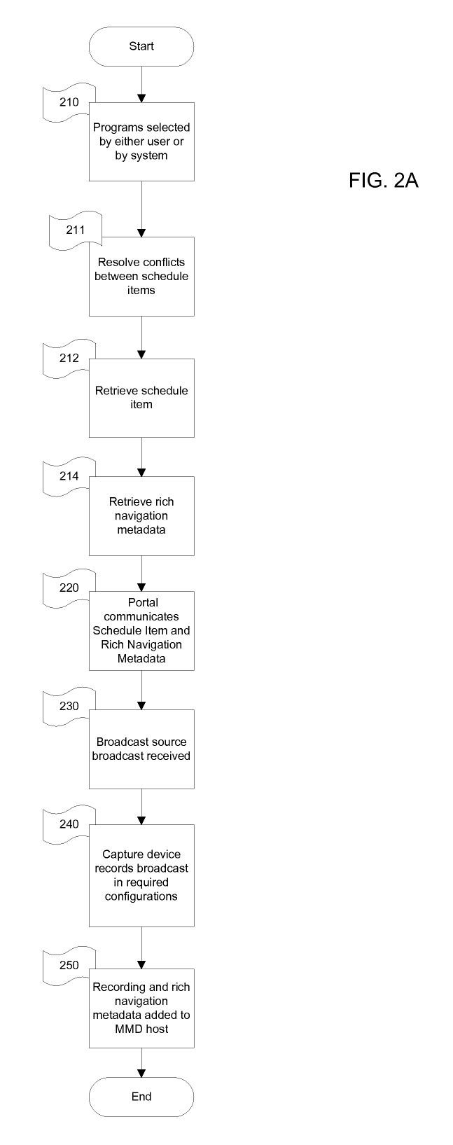

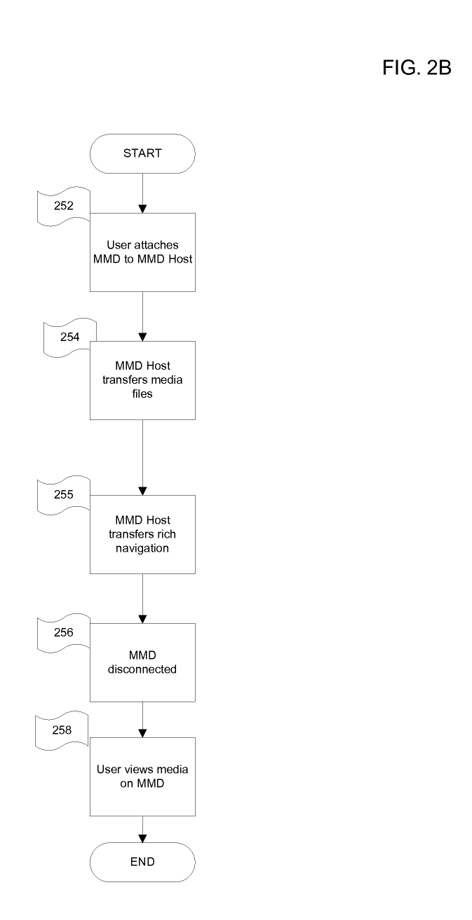

FIG. 2 depicts a typical usage of the capture system. At step 210 programs are selected for recording either by the user or by the capture portal 300 capture portal 300 may autonomously select programs for recording based on inferences drawn from the users past behavior, other users past behavior, or by factors not influenced by the users actions (such as advertising contracts). At step 211 conflicts between previously or newly scheduled schedule items are resolved. For example, if two broadcast television programs are desired to be recorded starting at 8 pm on the same night, the conflict resolver may look for alternate showings of either of the programs that have no conflicts or, alternatively delete the schedule item for the program the conflict resolver believes the user 1000 desires less based on either direct input from the user or on inferences drawn from the user's previous behavior or the behavior of users the conflict resolver believes have similar interests to the user. At step 212 the system retrieves the schedule items and then the rich navigation metadata at step 214. The information retrieved at steps 212 and 214 are then communicated from the capture portal to the Capture device at step 220. When, at step 230 the scheduled broadcast source is available the Capture Device 400 records the broadcast in the required configuration that are playable on the user 1000's MMD 600. At step 250 the recording and the rich navigation metadata are added to the MMD Host. Depending on the MMD Host the process of adding the recordings and the rich navigation metadata will vary—e.g. one popular MMD Host application is iTunes™ which has its own application programming interface that can be used.

FIG. 2b illustrates a typical use of an MMD once recordings and rich navigations have been added to a MMD Host 1070. The user attaches his MMD to the MMD Host at step 252. The MMD Host is comprised of hardware and software that may be physically attached to or part of the Capture Device 400 or connected to the Capture Device 400 through an interconnection network 1050. At step 254 the MMD Host transfers the recordings to the MMD and then, at step 255, it transfers the rich navigations to the MMD. At step 256 the user may disconnect the MMD from the MMD Host and at step 258 may watch or listen to recordings on the MMD.

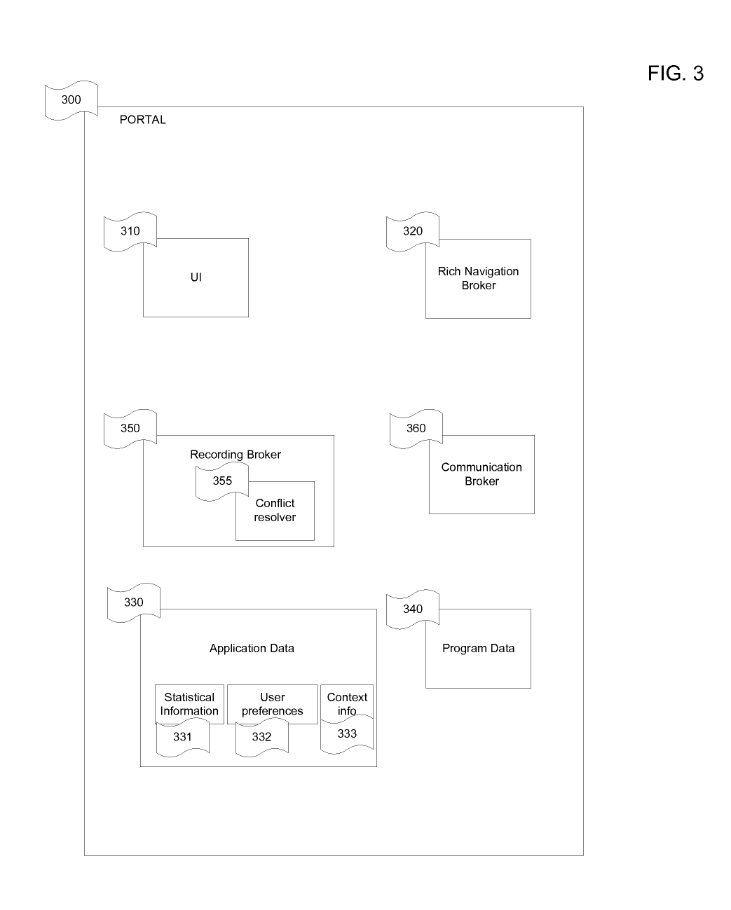

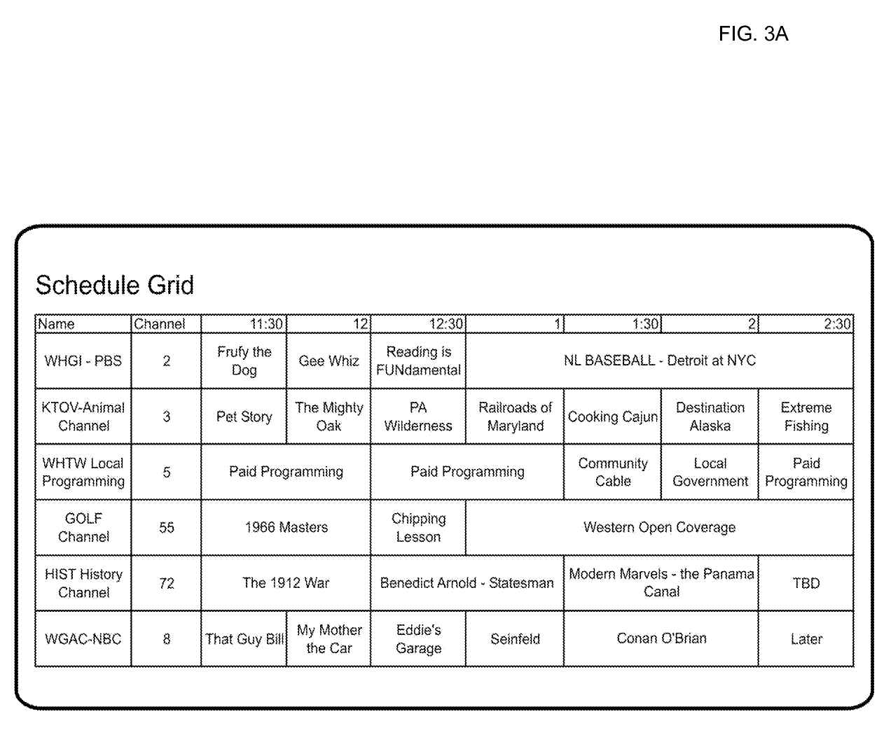

The capture portal 300, as illustrated in FIG. 3, has a UI module 310. Preferably, the graphical display presented to the user by the UI 310 is tailored to the individual preferences of the particular user and is formulated based on the data stored in the program information database 340 and the application data database 330. For example, some users prefer to be greeted by a full listing of programs at a given time and date displayed in a grid as in FIG. 3a. Other users will prefer that they be greeted with a list of programs that will air in the near future related to particular subjects, genres, actors, etc. as indicated by explicit preferences they have previously indicated or on implicit preferences that can be extrapolated from data in the databases 330 and 340. The combinations and permutations of “personalization” are myriad but it will be appreciated that the capture system provides very specialized personalization.

The UI 310 saves information related to user selections, context related to the user selection, user preference information, and other data items into the database 330. For example, a particular request for a recording of a program related to fishing might cause data to be saved to the database related to the program title, the time at which that user made the request, the time at which the recording is to take place, how many other recording requests the user made within a given amount of time around that request, how many other users are making similar requests, etc. The information stored in the databases 330 and 340 is then analyzed by the rich navigation broker 320 in order to produce rich navigation metadata for each user as required for the recordings to be made for that user. The information stored in the databases is also analyzed by the recording broker 350 such that recording may be autonomously scheduled by the capture system based on the analysis of the data and the system's perceived relevance of the recording to the mobile-consumer as well as the mobile-consumer's resources available to consume the autonomously recorded media. Conflicts between schedule items that occur at the same times are resolved by the conflict resolver 355. On either a push or pull basis information related to the scheduling of recording are transmitted by the communication broker 360 to the capture device 400. Similarly, rich navigation metadata is formulated by the rich navigation broker 320 and sent by or retrieved through the communication broker 360.

It should furthermore be appreciated that the capture portal 300 may span multiple physical machines for purposes of scalability, reliability, and performance and that no two modules need occupy the same physical machine nor does any single module need to reside solely on a single physical computer machine. Those skilled in the art will appreciate that the placement of these modules on physical computer machines will depend greatly on the expected number of users, simultaneously and/or in the aggregate, of the capture portal 300. Preferably, as the application is directed to high volume usage all of the modules in the capture portal 300 are spread across a “farm” of computers and share data with each other through common databases and programmatic interfaces that they expose to one another.

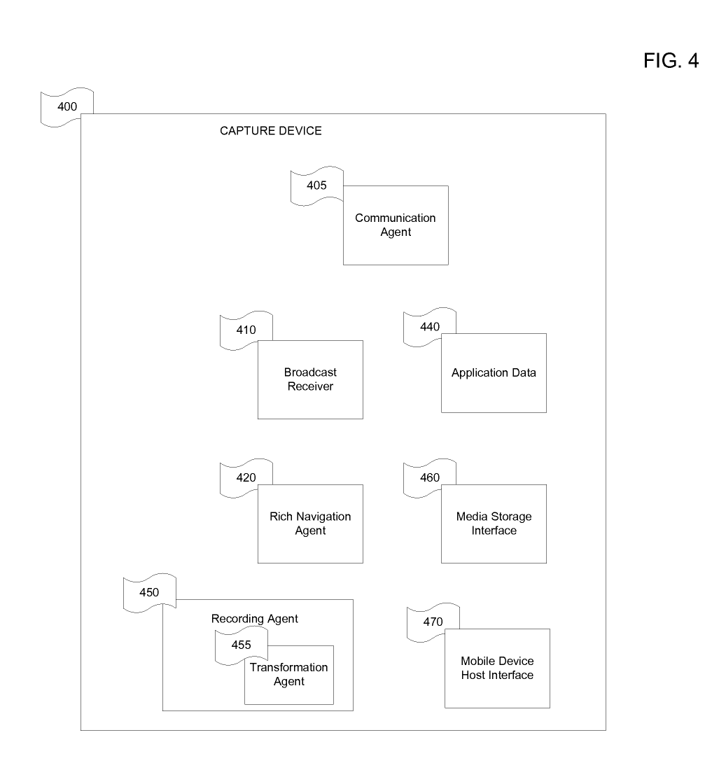

FIG. 4 is a block diagram of the Capture Device 400. The capture device 400 may tune to one or multiple broadcast sources through a broadcast receiver 410. Tuning is done at the direction of the recording agent 450, which acts on the schedule items pulled by or pushed to it through the communication agent 460. The schedule of items to be recorded will preferably be stored to in the application data database 440 until it is necessary to act upon them by the recording agent 420. In an exemplary embodiment the scheduled items are pushed by the communication broker 360 to the communication agent 460 at the time it is decided the item is to be recorded, and, periodically the communication agent 460 pulls a list of schedule items in order to verify that either some or all of its stored schedule items are valid. Other combination of push and pull transmission of schedule items are anticipated by the capture system as dictated by factors including, but not limited to, the bandwidth and the reliability of the connection between the communication agent 460 and the communication broker 360, frequency with which program information changes, etc. For example, at 10 pm on Tuesday Jan. 5, 2006 the communication broker 360 may receive a schedule item from the communication broker 350 indicating that on Wednesday Jan. 6, 2006 a recording should be made of the broadcast transmission on channel 5. Recordings made by the recording agent 450 may be stored to media storage, 1060, by way of the media storage interface 405. The media storage, 1060, may be local to the machine holding the recording agent 450 or it may be remote storage accessible over a network.

The schedule item will preferably include the preferred component media configurations for the transformation agent, 455, to output from the capture process, such that, for example, if the mobile consumer has one mobile device that could display audio accompanied slide shows and another that only accepted audio, the schedule item might indicate that the an audio track be captured in a specific configuration (E.g. AAC or MP3 among others) and that still frame images be captured (e.g. JPEG or GIF among other configurations) from the video portion. As another example, if the mobile-consumer has a video capable MMD which has a poor user interface for fast-forwarding within video, the output component media configuration might be “chaptered” video which has a five-minute chapter interval that, when combined with the appropriate rich navigation skips to the next chapter when fast-forward is invoked on the MMD.

Segmented video created from a non-segmented broadcast transmissions may be used to create rich-navigation experiences including, but not limited to, a version of the program without commercials, a versions of the program with replaceable commercials, a director's cut version of a movie that is comprised of segments from a short broadcast of “director's additions” and some or all of the segments of the normal release of the program, and “time-adjusted programs”. Time adjusted programs herein are defined as recordings for which more segments are recorded than the mobile-consumer will wish to view. For example, many sports programs such as baseball games and football games are variable length and, if the resources are available it makes sense to continue recording on the channel of the sports broadcast beyond the pre-scheduled end-time according to the program guide data. According to this example, segments that are known to have been recorded after the actual end-time of the game may be discarded once the actual end time of the game is known. Accordingly, the rich navigation metadata would only include the needed segments of the game. As another example, an abbreviated version of a sports program might be made through the use of a time-adjusted program by dropping segments from the full set comprising the game—this would be useful in many circumstances such as, but not limited to, mobile-consumers that want to watch a three hour football game in forty minutes. In a like manner, the audio and video of a source broadcast transmission may be saved in separate component media configurations, e.g. the audio as MP3 and the video in “silent” MPEG4, such that alternate audio can be played along side the video on the target MMD such as, but not limited to, alternate languages or director's commentary. It will be appreciated that there are numerous combinations of component media configurations that may enhance the end user experience when particular characteristics of the capture device, MMD, rich navigation metadata, contextual information, and user preferences are taken into account. The recording agent 450 may then store the schedule item's information and, at the specified time begin capturing the specified broadcast transmission in the specified configurations. Those skilled in the art will appreciate that for purposes of encoding the broadcast transmission into other configurations the recording broker 350 may make use of a variety of commercially available software or hardware components such as Microsoft DirectShow or an MPEG2 hardware encoder and that the hardware or software employed for encoding will vary depending on the platform of the capture device (e.g. Windows, Linux, etc.) and the desired output configuration (e.g. AAC audio, MP3 audio, MPEG4 video, JPEG, etc.).

In a manner similar to the recording agent 450, the rich navigation agent 420 makes use of the rich navigation metadata the communication agent 460 either pulls or has pushed to it from the rich communication broker 360. This metadata is stored in the application data database 440 until a corresponding recording is completed at which time the rich navigation agent 420 interfaces through the MMD host interface 470 to the MMD hosts 1070_{1 . . . N} in order to add both the recording and the associated rich navigation data for that recording to the MMD hosts 1070_{1 . . . N} so that the MMD hosts 1070_{1 . . . N} may then transfer the recording and the rich navigation metadata to the respective MMDs 600_{1 . . . N}.

It is anticipated that the capture device 400 may span multiple physical pieces of hardware and that modules comprising the capture device need not be located on the same physical computing machine—e.g. the broadcast receiver 410 may be a USB TV tuner device connected to the device hosting the recording broker 350 via a USB wire, or among other possibilities, it may be a PCI card in one computer along with a UDP/IP output streaming to the recording agent 450 located on a separate physical machine.

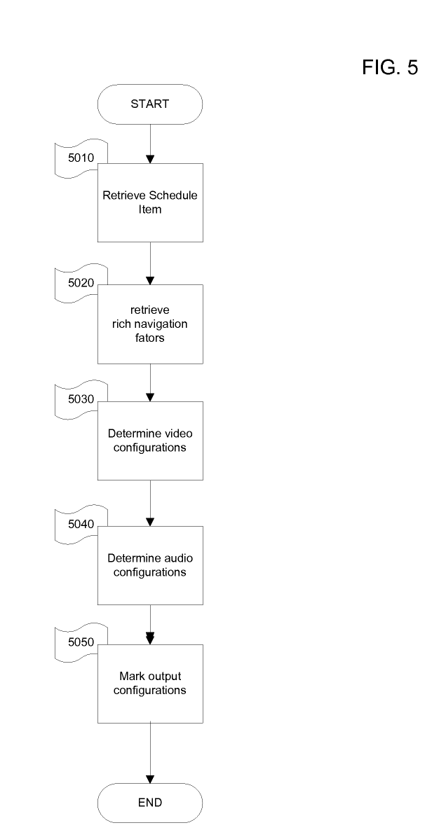

FIG. 5 depicts an exemplary process within the capture portal 300 for determining the component media configuration outputs. At step 5010 a schedule item is retrieved and at step 5020 rich navigation metadata related to the schedule item are also retrieved from the application data database 330. At step 5020 the video/graphical capabilities of the first MMD belonging to the mobile-consumer are determined. If it is determined at step 5020 that the MMD is video capable (e.g. it can process video codecs such as MPEG2, MPEG4, AVI, WMA, etc.), or it is determined that the MMD has other graphics capabilities that may be made use of (e.g. slide-show capabilities or even text display that can be synchronized to an audio track), then at step 5030 it will be determined whether rich navigation metadata should be taken into account before deciding the component media configurations at capture. For example, in the highlight reel example and time-adjusted recording examples discussed above the rich navigation metadata taken into account may be, among others, that the source broadcasts relate to sports, that the source broadcasts collectively span multiple hours, the mobile-consumer has indicated a preference for abbreviated viewing, and in the past the mobile-consumer has typically watched the previous day's sports related material during the one hour period between 9 am and 10 am. This data would strongly indicate that a composite recording should be made for time-abbreviated viewing. As will be discussed later, this does not preclude the possibility that other rich navigation metadata will also indicate other component media configurations for the same programs, in which, for example, the source broadcasts may be played in their entirety.

The variety of ways that component media configurations can be utilized with rich navigations to enhance the user experience are myriad. For example, take a situation where a mobile-consumer indicates to the capture system that he will be going on a trip to Italy and furthermore he will be going to Napoli, Rome, and Florence. The capture system may record segmented audio or video from broadcast transmissions related to those cities according to data available from the program guide, other users, or even third parties, and create a rich navigation that amounts to a 1 hour guided tour for the mobile-consumer to carry with him while on vacation.

Once the video/graphical component configurations of the recording have been determined at step 5030, then at step the 5040 the audio component configurations are determined. As discussed above, depending on the data available from the databases 340 and 350 the process 5040 may determine, for example, that the audio may be recorded with the video with primary audio source, or if the MMD supports it with multiple audio tracks, or separately recorded from the video, etc. In any case, the component media configurations of the audio will be complementary to that of the video, if any, such that the audio will fit into the various rich navigations and component media configurations decided upon for the end mobile-consumer experiences. At step 5050 the schedule item is updated to reflect the results of the processes 5030 and 5040.

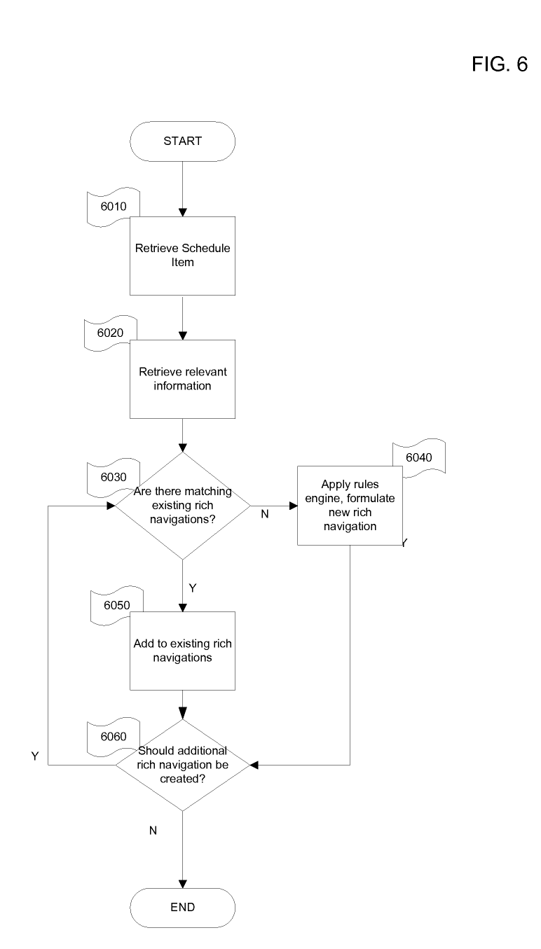

FIG. 6 depicts an exemplary process within the capture portal for determining the rich navigation metadata to associate with a scheduled item. At step 6010 a schedule item is retrieved. Information relevant to the schedule item is retrieved at step 6020 from the pertinent databases 330 and 340, such information including but not limited to contextual information, user preferences, program information, and statistical information. For example, relevant information may include, but is not limited to, the time and date at which the schedule item was created, the intended MMDs that the schedule item might be targeting, the genre of the program, key words related to the program, the number of other mobile-consumers who have created schedule items pertaining to the same broadcast program, the important world events occurring at the time the item was scheduled, etc. At step 6030 algorithms are applied to determine whether a pre-existing set of rich navigation meta-data may apply to the new schedule item. If matching rich navigation metadata exists, then the schedule item is associated with it at step 6050. For example, if the relevant information retrieved at step 6020 indicates that the program to which the schedule item refers is a sports program being aired the same day, and if there is a preexisting set of rich navigation metadata for the mobile-consumer, such as a folder metadata called “today” and a playlist called “sports”, then the schedule item will be associated with that metadata such that, if on the same day the recorded program is transferred to the MMD along with the associated rich navigation metadata the recorded item will be added to the playlist “sports” in the “today” folder.

If no matching rich navigation metadata is found to exist at step 6020, then algorithms are applied by a rules engine at step 6040 to formulate new rich navigation metadata. It will be appreciated by those skilled in the art that the rules that can be formulated and applied are almost infinite in their number and that the capture system anticipates that rules be formulated either statically or dynamically in many different ways. For example, rules may be formulated in such ways as, but not limited to, formulation by the mobile-consumers themselves either directly or indirectly (through questionnaires), formulation by the system or by others based on analysis of data that has been gathered pertaining to the scheduling and consumption of recordings, or by input from experts.

Once the schedule item has been associated with rich navigation metadata at either steps 6040 or 6050, it is determined at step 6060 whether additional rich navigation metadata should be associated with the same schedule item. This determination may be bases on factors including, but not limited to, whether all the contextual data related to the schedule item are associated with an existing rich navigation, whether sets of contextual data typically warrant their own rich navigation metadata, whether at step 6040 all rules were run against all contextual data related to the schedule item, etc. If additional rich navigation metadata should be created the process returns to step 6030. If no more rich navigation metadata be associated with the schedule item, the process ends.

1. A capture system for creating recordings associated with a user, said capture system comprising:
a capture portal, including:
a recording broker for creating a schedule for making said recordings;
a rich navigation broker, for deriving rich navigation metadata associated with said recordings.
a capture device, including:
a communication agent for receiving information, said information including a recording schedule and rich navigation metadata;
a broadcast receiver for receiving multimedia;
a recording agent for beginning a first recording of a segment of said multimedia based on said recording schedule;
a rich navigation agent for associating rich navigation metadata with said recording.

2. A capture portal for managing recordings associated with a user, said portal comprising:
a recording broker for creating a schedule for making said recordings;
a rich navigation broker, for deriving rich navigation metadata associated with said recordings.

3. The capture portal of claim 2, further comprising;
a communication broker for communicating said schedule and said rich navigation metadata to a capture device for recording said recordings.

4. The capture portal of claim 3, wherein said schedule references
a first recording associated with a first broadcast period; and
a second recording having a first and a second segment, the first segment associated with a second broadcast period contained within the first broadcast period, and the second segment associated with a third broadcast period outside of the first broadcast period,
said recording broker further comprising a conflict resolver that removes said first segment from said recording schedule.

5. The capture portal of claim 3, wherein said schedule references
a first recording associated with a first broadcast period; and
a second recording having a first and a second segment, the first segment associated with a second broadcast period contained within the first broadcast period, and the second segment associated with a third broadcast period outside of the first broadcast period,
said recording broker further comprising a conflict resolver that removes said second recording from said recording schedule.

6. The capture portal of claim 5, wherein said second recording includes a first set of information, and said conflict resolver further adds a third recording to said schedule, said third recording including said first set of information.

7. A capture device for multimedia content comprising:
a communication agent for receiving information, said information including a recording schedule and rich navigation metadata;
a broadcast receiver for receiving multimedia;
a recording agent for beginning a first recording of a segment of said multimedia based on said recording schedule;
a rich navigation agent for associating rich navigation metadata with said recording.

8. The capture device of claim 7, wherein:
said recording agent begins a second recording of a second segment of said multimedia based on said recording schedule; and
said rich navigation metadata defines a playing sequence comprising a first position and a second position, said rich navigation agent associating said first position with said first recording and said second position with said second recording.

9. The capture device of claim 8, wherein said rich navigation metadata includes a playlist for defining said playing sequence, said rich navigation agent associating said playlist with said first recording.

10. The capture device of claim 8, wherein said rich navigation agent derives a playlist based on said rich navigation metadata, said playlist defining said playing sequence.

11. The capture device of claim 10, wherein said rich navigation metadata includes a broadcast channel associated with said first recording, said rich navigation agent deriving said playlist based on said broadcast channel.

12. The capture device of claim 7, wherein said rich navigation metadata includes a hierarchy of nodes, said rich navigation agent associating said first recording with a node in said hierarchy.

13. The capture device of claim 9, wherein said rich navigation metadata includes a hierarchy of nodes, said rich navigation agent associating said playlist with one of said nodes.

14. The device of claim 8, wherein said playing sequence defines an order for playing back said recordings.

15. The capture device of claim 8, wherein said second position is adjacent to said first position in said playing sequence; and said recording agent creates a composite recording by splicing said first recording and said recording.

16. The capture device of claim 7 wherein, the device further comprises:
a transforming agent for creating a first transformation of said first recording based on said rich navigation metadata, said first transformation having a different format from said recording.

17. The capture device of claim 16, wherein said recording agent further records said recording for a recording period specified in said recording schedule, the capture device further comprising:
said transforming agent creating said first transformation during said recording period.

18. The capture device of claim 7, wherein said segment comprises a full program.
